(19) United States
(12) Patent Application Publication
(10) Pub. No.: US 2026/0303982 A1
(43) Pub. Date: Oct. 1, 2026

(54) IMAGE PROCESSING SYSTEM, IMAGE PROCESSING METHOD, AND INFORMATION STORAGE MEDIUM

(71) Applicant: Sony Interactive Entertainment Inc., Tokyo (JP)

(72) Inventors: Dai Matsunaga, Kanagawa (JP); Takashi Amada, Tokyo (JP); Wataru Kawamata, Kanagawa (JP); Nobuyuki Yasue, Kanagawa (JP)

(73) Assignee: Sony Interactive Entertainment Inc., Tokyo (JP)

(21) Appl. No.: 19/578,596

(22) Filed: Mar. 25, 2026

Related U.S. Application Data
(60) Provisional application No. 63/779,313, filed on Mar. 28, 2025.

(51) Int. Cl. H04N 23/76; G06T 3/40; G06V 10/60

(52) U.S. Cl. CPC H04N 23/76; G06T 3/40; G06V 10/60

(57) ABSTRACT

Provided is an image processing system that calculates a first parameter indicating brightness of a first processed frame on the basis of luminance distribution of pixels contained in the first processed frame, performs, for the first processed frame, distribution transformation that transforms the luminance distribution of the pixels contained in the first processed frame into luminance distribution close to that of pixels contained in a learning input frame on the basis of the first parameter to generate a second processed frame, inputs the second processed frame to a resolution conversion section to generate a third processed frame having an estimated number of pixels each of which has a pixel value having a linear relation with luminance, and performs inverse distribution transformation for the third processed frame on the basis of the first parameter to generate a fourth processed frame.

### CROSS-REFERENCE TO RELATED APPLICATION

This application claims the benefit of U.S. Provisional Patent Application No. 63/779,313 filed Mar. 28, 2025, the contents of which is incorporated herein by reference in its entirety for all purposes.

### TECHNICAL FIELD

The present invention relates to an image processing system, an image processing method, and an information storage medium.

### BACKGROUND ART

Technologies for estimating high-quality still images by using machine learning models on the basis of low-quality still images (technologies called super-resolution) have hitherto been known (see Non Patent Document 1 identified below). In addition, estimation of high-quality moving images achieved on the basis of low-quality moving images with reference to previous frame information has also been known.

### NON PATENT DOCUMENT

Non Patent Document 1: Chao Dong, Chen Change Loy, Kaiming He, Xiaoou Tang. Learning a Deep Convolutional Network for Image Super-Resolution, in Proceedings of European Conference on Computer Vision (ECCV), 2014.

### SUMMARY OF THE INVENTION

### Problems to be Solved by the Invention

The machine learning models noted above are trained using a plurality of pieces of training data. For example, training data including learning input frames and learning output frames is used for learning. It is preferable herein that luminance of pixels contained in the learning input frames and the learning output frames be widely distributed to allow the machine learning models to achieve high-quality image estimation for various types of input frames. However, some input frames input to the machine learning models have luminance distribution considerably different from the luminance distribution of the learning input frames and the learning output frames. In this case, high-quality estimated images cannot be output from the machine learning models.

An object of the present disclosure is to provide an image processing system, an image processing method, and a program capable of achieving high-quality image estimation for input frames having various luminance distribution.

### Means for Solving the Problems

An image processing system includes a processor, a storage unit that stores a command executed by the processor, and a resolution conversion section including a machine learning model, and a display unit. The machine learning model is a model trained on the basis of training data that includes a learning input moving image containing a learning input frame having a predetermined input number of pixels and a learning output moving image containing a learning output frame having an estimated number of pixels larger than the input number of pixels. The processor acquires a first processed frame that has the input number of pixels each of which has a pixel value having a linear relation with luminance, calculates a first parameter indicating brightness of the first processed frame on the basis of luminance distribution of the pixels contained in the first processed frame, performs, for the first processed frame, distribution transformation that transforms the luminance distribution of the pixels contained in the first processed frame into luminance distribution close to that of the pixels contained in the learning input frame on the basis of the first parameter to generate a second processed frame, inputs the second processed frame to the resolution conversion section to generate a third processed frame having the estimated number of pixels each of which has a pixel value having a linear relation with luminance, and performs, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.

### BRIEF DESCRIPTION OF THE DRAWINGS

FIG. 1 is a diagram illustrating an example of a hardware configuration of an image processing system.

FIG. 2A is a diagram illustrating an overview of the image processing system.

FIG. 2B is a diagram illustrating an overview of the image processing system.

FIG. 3 is a diagram schematically illustrating processes performed by the image processing system.

FIG. 4 is a functional block diagram illustrating an example of functions implemented by the image processing system.

FIG. 5 is a diagram for explaining processing performed by a rendering section.

FIG. 6 is a diagram for explaining processing performed by a first non-linear frame acquisition section.

FIG. 7 illustrates histograms each representing a relation between pixel values in a corresponding input frame and frequencies.

FIG. 8 is a flowchart illustrating an example of a flow of a process executed by the image processing system.

FIG. 9 is a flowchart illustrating an example of a flow of a process executed by the image processing system.

FIG. 10 is a flowchart illustrating an example of a flow of a process executed by the image processing system.

### MODE FOR CARRYING OUT THE INVENTION

By way of example, an embodiment of an image processing system according to the present disclosure will hereinafter be described with reference to the drawings.

### 1. Hardware Configuration of Image Processing System

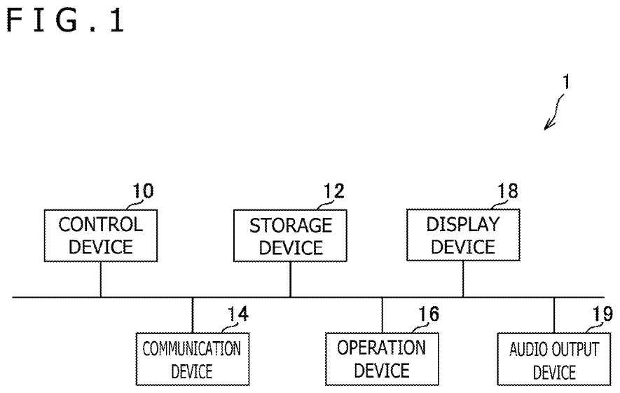

FIG. 1 is a diagram illustrating an example of a hardware configuration of an image processing system 1. For example, the image processing system 1 is a computer, such as a game console (game machine). As illustrated in FIG. 1, the image processing system 1 includes a control device 10, a storage device 12, a communication device 14, an operation device 16, a display device 18, and an audio output device 19.

For example, the control device 10 includes a program control device, such as a central processing unit (CPU, hereinafter simply referred to as a processor) which operates under a program installed in the image processing system 1. The control device 10 further includes a graphics processing unit (GPU) which forms images on a frame buffer on the basis of graphics commands and data supplied from the CPU.

For example, the storage device 12 includes a main storage device such as a read only memory (ROM) and a random access memory (RAM) and an auxiliary storage device such as a hard disk drive (HDD) and a solid state drive (SSD). The storage device 12 stores programs and the like executed by the control device 10. The storage device 12 stores game programs (game software), for example, in addition to programs for implementing various functions of the image processing system 1 as will be discussed below. Specifically, the storage device 12 stores commands executed by the processor, and a resolution conversion section 100 (discussed below) including a machine learning model 200. Moreover, the storage device 12 has a sufficient region dedicated for a frame buffer where images are formed by the GPU.

For example, the communication device 14 is a communication interface, such as an Ethernet (registered trademark) module and a wireless local area network (LAN) module.

The operation device 16 is a user interface such as a keyboard, a mouse, and a controller of a game console, and is configured to receive operation input from a user and output a signal indicating contents of this input to the control device 10.

The display device 18 is a display device such as a liquid crystal display and an organic electroluminescent (EL) display, and is configured to display various images in accordance with instructions issued from the control device 10.

For example, the audio output device 19 is a speaker or the like, and is configured to output sounds indicated by audio date generated by the image processing system 1.

Note that the image processing system 1 may include an optical disk drive for reading an optical disk such as a digital versatile disc (DVD)-ROM and a Blu-ray (registered trademark) disk, a universal serial bus (USB) port, and others in addition to the devices described above.

### 2. Overview of Image Processing System

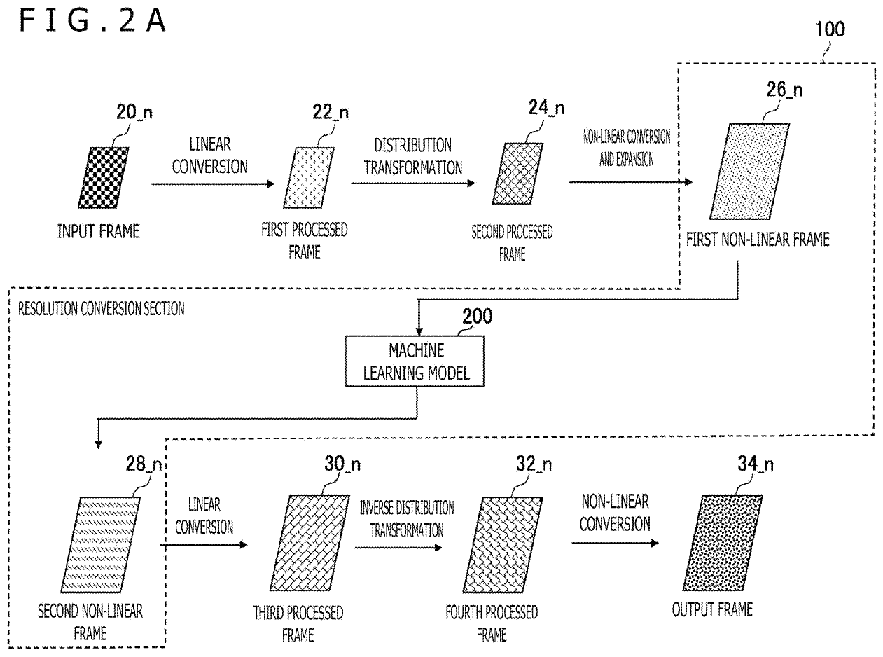

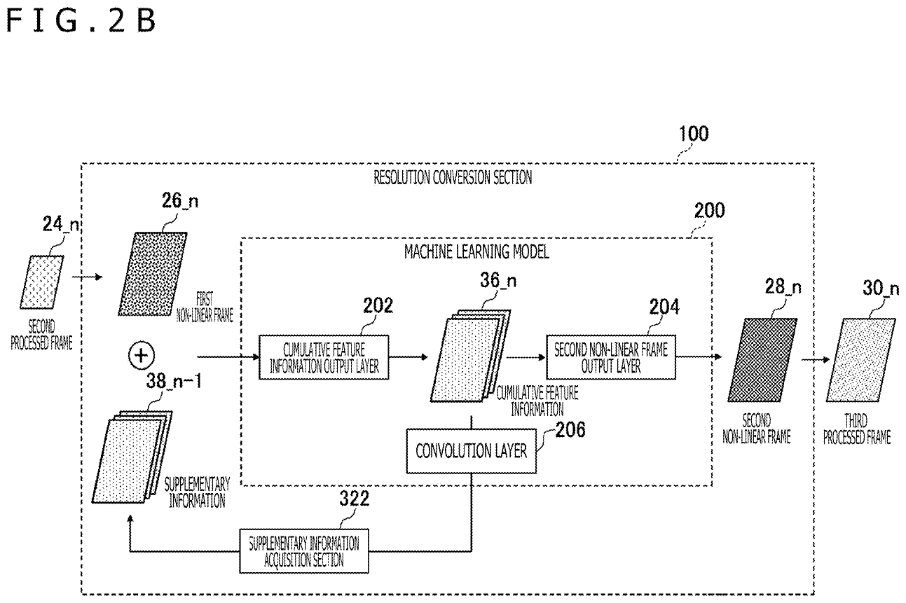

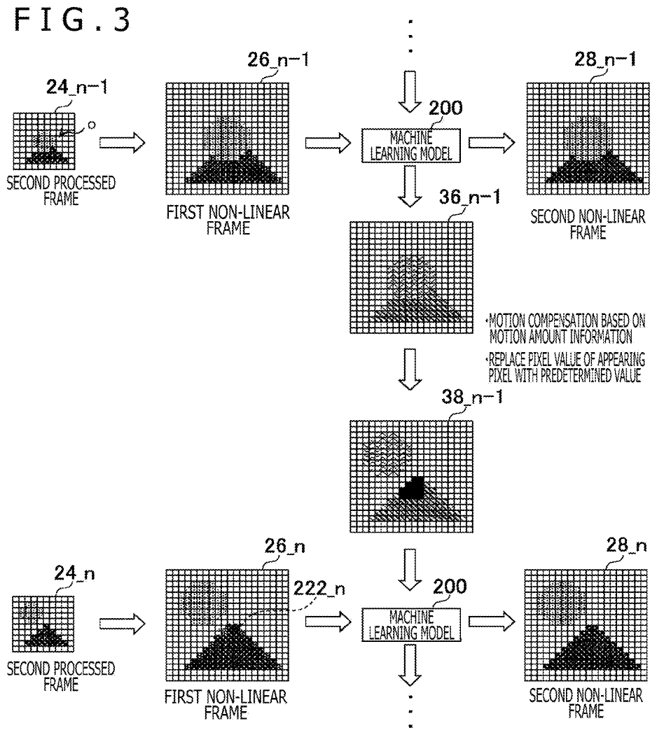

FIGS. 2A and 2B and FIG. 3 are diagrams schematically illustrating processes performed by the image processing system 1. According to the present embodiment discussed by way of example, the image processing system 1 is adopted for the purpose of quality improvement of play moving images of a game. The play moving images are moving images generated in accordance with game programs executed by the control device 10, input received by the operation device 16 from the user, and the like, and include a plurality of still images (frames) as time-series data. The following are main processes performed by the image processing system 1.

### (1) Generation of Input Frames

First, the image processing system 1 generates an image (input frame 20) containing an image of at least one game object as viewed from a predetermined viewpoint, by rendering three-dimensional data representing this game object. The input frame 20 thus generated is an image having a predetermined number of pixels (input number of pixels) and predetermined image quality (input image quality). The input frame 20 is generated every predetermined time. For example, the number of pixels of the input frame 20 is 1920×1080 (1080p). Each of the input frames 20 thus generated is temporarily stored in the storage device 12 and then subjected to the following processes, instead of being displayed on the display device 18 without change. Note that, while processing for an nth input frame 20_n will chiefly be discussed below by way of example, similar processing is executed also for the other input frames 20 (i.e., n=2, 3, and up to N).

### (2) Acquisition of First Processed Frame

The image processing system 1 acquires a first processed frame 22 which contains the input number of pixels each of which has a pixel value having a linear relation with luminance. Specifically, the image processing system 1 performs, for the acquired nth input frame 20_n, γ-conversion for establishing a linear relation between pixel values of respective pixels and luminance, to acquire an nth first processed frame 22_n.

### (3) Acquisition of Second Processed Frame

The image processing system 1 performs distribution transformation for the nth first processed frame 22_n on the basis of a first parameter to generate an nth second processed frame 24_n. The distribution transformation is a process performed for each of the first processed frames 22 to transform luminance distribution of the pixels contained in the corresponding first processed frame into luminance distribution close to that of pixels contained in a learning input frame.

### (4) Acquisition of First Non-Linear Frame

The image processing system 1 performs, for the acquired nth second processed frame 24_n, γ-conversion for providing a γ-characteristic appropriate for processing by the machine learning model 200, and performs expansion for this frame to generate a first non-linear frame 26. Specifically, the image processing system 1 performs the γ-conversion by inputting the nth second processed frame 24_n to a transfer function constituting a perceptual quantizer and performs expansion for this frame to acquire an nth first non-linear frame 26_n which contains the number of pixels (an intermediate number of pixels) larger than the input number of pixels. For example, the intermediate number of pixels is 3840×2160 (4K).

It should be noted herein that the nth first non-linear frame 26_n has the number of pixels larger than the number of pixels of the nth second processed frame 24_n but does not necessarily have sufficiently improved image quality. That is, image quality of a frame does not simply refer to the number of pixels (level of resolution). For example, image quality of a frame may be evaluated on the basis of each or total consideration of a level of a signal-to-noise (SN) ratio, a level of reproducibility of a spatial frequency, a level of time stability (reduction of artifacts and flickering during continuous display of a plurality of frames), and other factors in comparison with those of a reference frame.

### (5) Acquisition of Second Non-Linear Frame

The image processing system 1 inputs the nth first non-linear frame 26_n to the machine learning model 200 to acquire an nth second non-linear frame 28_n. The nth second non-linear frame 28_n is an image which has the same number of pixels (an estimated number of pixels) as the intermediate number of pixels and image quality (estimated image quality) equal to or higher than the input image quality.

Note herein that the machine learning model 200 receives input of (n−1)th supplementary information 38_n−1 in addition to the nth first non-linear frame 26_n (see FIGS. 2B and 3). The (n−1)th supplementary information 38_n−1 is information based on (n−1)th cumulative feature information 36_n−1 indicating features of the 1st to (n−1)th input frames 20. Details of cumulative feature information 36 and supplementary information 38 will be discussed below.

Note that the machine learning model 200 is a model trained on the basis of training data which includes a learning input moving image containing a learning input frame which has a predetermined input number of pixels and a learning output moving image containing a learning output frame which has the estimated number of pixels larger than the input number of pixels. Details of the machine learning model 200 will be discussed below.

### (6) Acquisition of Cumulative Feature Information

The machine learning model 200 has a cumulative feature information output layer 202 which receives input of the nth first non-linear frame 26_n and the (n−1)th supplementary information 38_n−1 and which outputs nth cumulative feature information 36_n indicating features of the 1st to nth first non-linear frames 26 (see FIG. 2B). The image processing system 1 acquires the nth cumulative feature information 36_n.

The acquired nth cumulative feature information 36_n is input to a second non-linear frame output layer 204, while the nth second non-linear frame 28_n is output from the second non-linear frame output layer 204 (see FIG. 2B). Note that the acquired nth cumulative feature information 36_n is also stored in the storage device 12 and provided for estimation of an (n+1)th second non-linear frame 28_n+1 corresponding to a subsequent first non-linear frame 26 ((n+1)th first non-linear frame 26_n+1).

### (7) Acquisition of Supplementary Information

As described above, the (n−1)th cumulative feature information 36_n−1 is information indicating features of the 1st to (n−1)th input frames 20 (eventually, the 1st to (n−1)th input frames 20). By using the cumulative feature information 36_n−1, which includes cumulative previous information associated with the second processed frames 24 as noted above, for estimation of the nth second non-linear frame 28_n, the second non-linear frame 28_n having high image quality is acquirable on the basis of more information available for estimation.

However, when the nth first non-linear frame 26_n and the (n−1)th cumulative feature information 36_n−1 are input to the machine learning model 200 without change after motion or the like of the displayed game object between an (n−1)th second processed frame 24_n−1 and the nth second processed frame 24_n, a phenomenon (what is generally called a ghost phenomenon) which displays an afterimage of the game object displayed in the (n−1)th second processed frame 24_n−1 may occur.

For solving this problem, the image processing system 1 applies various corrections described below to the (n−1)th cumulative feature information 36_n−1 on the basis of information obtained at the time of rendering (motion vector, depth buffer, or the like), to acquire the (n−1)th supplementary information 38_n−1 (see FIGS. 2B, 3). As described above, the acquired (n−1)th supplementary information 38_n−1 is input to the machine learning model 200 together with the nth first non-linear frame 26_n, and provided for estimation of the nth second non-linear frame 28_n.

### (8) Acquisition of Third Processed Frame

The image processing system 1 performs, for the nth second non-linear frame 28, γ-conversion for restoring a γ-characteristic equivalent to that of the nth second processed frame 24_n to generate an nth third processed frame 30_n. Specifically, the image processing system 1 inputs the nth second non-linear frame 28_n to the inverse function of the transfer function used at the time of generation of the nth first non-linear frame 26_n, to acquire the nth third processed frame 30_n containing pixels each of which has a pixel value having a linear relation with luminance.

### (9) Acquisition of Fourth Processed Frame

The image processing system 1 performs inverse distribution conversion for the nth third processed frame 30_n to generate an nth fourth processed frame 32_n. The inverse distribution conversion is an inverse process of the distribution transformation performed for generating the nth second processed frame 24_n from the nth first processed frame 22_n. Specifically, the image processing system 1 performs, for the nth third processed frame 30_n having luminance distribution close to luminance distribution of pixels contained in the learning input frame, a process for restoring luminance distribution of the pixels contained in the nth first processed frame 22_n, to generate the nth fourth processed frame 32_n.

### (10) Acquisition of Output Frame

The image processing system 1 performs non-linear conversion for the nth fourth processed frame 32_n to generate an nth output frame 34_n. This non-linear conversion is an inverse process of the γ-conversion performed for generating the nth first processed frame 22_n from the nth input frame 20_n. This process generates the nth output frame 34_n in which a relation between pixel values and luminance is similar to that of the nth input frame 20_n.

As discussed above, distribution transformation for transforming luminance distribution into luminance distribution close to that in the learning input frame is carried out before output of an estimated image. In this manner, a high-quality estimated image can be output even in cases of input of the input frame 20 having luminance distribution considerably different from that in the learning input frame and the learning output frame. Note herein that appropriate transformation of luminance distribution cannot be achieved by performing distribution transformation for the input frame 20 due to non-linearity of the relation between the pixel values and the luminance of the input frame 20. According to the present embodiment, appropriate transformation of luminance distribution is achievable by applying distribution transformation to the first processed frame 22 generated from the input frame 20 by linear conversion.

Moreover, the image processing system 1 according to the present embodiment inputs the second processed frame 24 to the resolution conversion section 100 to generate the third processed frame 30 containing an estimated number of pixels each of which has a pixel value having a linear relation with luminance. In this case, the third processed frame 30 is estimated on the basis of the supplementary information 38 including previous cumulative information, in addition to the second processed frame 24 corresponding to the current input frame 20. Accordingly, the third processed frame 30_n having high image quality is acquirable by use of more information available for estimation. Details of the image processing system 1 will hereinafter be discussed.

### 3. Functions Implemented by Image Processing System

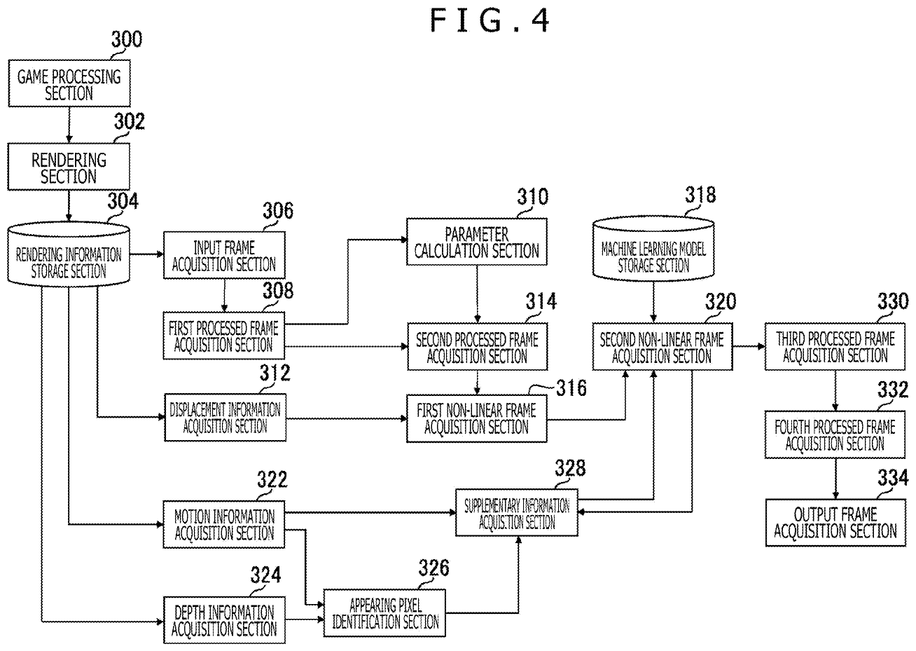

FIG. 4 is a functional block diagram illustrating an example of functions implemented by the image processing system 1. As illustrated in FIG. 4, the image processing system 1 implements a game processing section 300, a rendering section 302, a rendering information storage section 304, an input frame acquisition section 306, a first processed frame acquisition section 308, a parameter calculation section 310, a displacement information acquisition section 312, a second processed frame acquisition section 314, a first non-linear frame acquisition section 316, a machine learning model storage section 318, a second non-linear frame acquisition section 320, a motion information acquisition section 322, a depth information acquisition section 324, an appearing pixel identification section 326, a supplementary information acquisition section 328, a third processed frame acquisition section 330, a fourth processed frame acquisition section 332, and an output frame acquisition section 334. The game processing section 300, the rendering section 302, the input frame acquisition section 306, the first processed frame acquisition section 308, the parameter calculation section 310, the displacement information acquisition section 312, the second processed frame acquisition section 314, the first non-linear frame acquisition section 316, the second non-linear frame acquisition section 320, the motion information acquisition section 322, the depth information acquisition section 324, the appearing pixel identification section 326, the supplementary information acquisition section 328, the third processed frame acquisition section 330, the fourth processed frame acquisition section 332, and the output frame acquisition section 334 are chiefly implemented by the control device 10. The rendering information storage section 304 and the machine learning model storage section 318 are chiefly implemented by the storage device 12. Note that the game processing section 300, the rendering section 302, and the rendering information storage section 304 are functions provided by game software.

### Game Processing Section

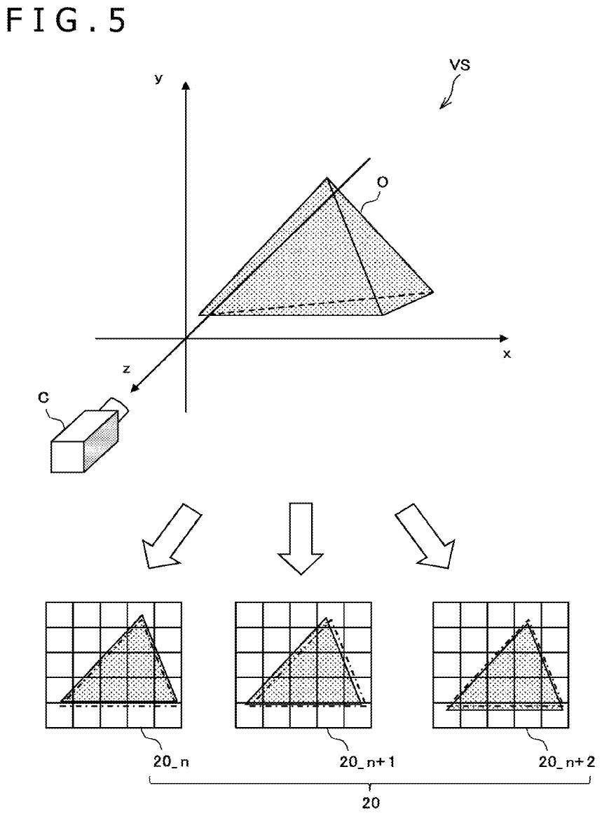

The game processing section 300 executes various processes associated with games. For example, the game processing section 300 executes a process for arranging a game object O in a virtual three-dimensional space VS, a process for operating or shifting the game object O, a process for changing a viewpoint C from which the virtual three-dimensional space VS is viewed, and other processes in accordance with a game program executed by the control device 10 or input received by the operation device 16 from the user (see FIG. 5). The game object O includes a primitive indicated by three-dimensional data, such as a polygon. The three-dimensional data includes geometric information indicating positions of vertexes or the like, phase information indicating how the vertexes are connected to each other, and attribute information such as colors.

### Rendering Section

FIG. 5 is a diagram illustrating processing performed by the rendering section 302. The rendering section 302 generates 1st to Nth (N is a natural number equal to or larger than 2) input frames 20 by executing rendering (image forming) of three-dimensional data indicating the one or more game objects O viewed from the predetermined viewpoint C. The rendering section 302 executes rendering on the basis of results of the various processes carried out by the game processing section 300. Specifically, the rendering section 302 executes vertex processing (vertex shading) and pixel processing (pixel shading) on the basis of three-dimensional data indicating the game object O arranged in the virtual three-dimensional space VS. The vertex processing includes coordinate conversion (perspective projection) from a view coordinate system into a screen coordinate system. As described below, numerical values associated with displacement of the viewpoint C are added to a perspective projection matrix (camera matrix) used for the coordinate conversion. The rendering section 302 may execute rendering on the basis of light source information, depth information (depth buffer), texture information, normal information, and the like. For example, the rendering section 302 may execute a process for applying effects such as a depth of field (DoF) and motion blurs, in addition to the foregoing processes. The processes performed by the rendering section 302 may appropriately be set by a developer of game software or the like. Note herein that the developer of game software or the like may adjust texture MIP in accordance with the estimated number of pixels of the third processed frame 30 or the like. In this manner, generation of noise such as moire in the third processed frame 30 can be reduced. Moreover, the developer of game software or the like may set a fixed parameter described below for each of the input frames 20 in accordance with game scenes beforehand, and the rendering section 302 may acquire this fixed parameter together with the input frame 20.

Note herein that the rendering section 302 generates each of the input frames 20 by executing rendering such that the viewpoint C is displaced for each of the input frames 20. In this case, the rendering section 302 displaces the viewpoint C for each of the input frames 20 even when the game processing section 300 fixes the viewpoint C at a predetermined position. As a result, the position of the displayed game object O is displaced for each of the input frames 20_n, 20_n+1, and 20_n+2 as illustrated in FIG. 5. In other words, the rendering section 302 applies jitters during generation of each of the input frames 20. Specifically, the rendering section 302 displaces the viewpoint C for each of the input frames 20 by adding a numerical value corresponding to a size smaller than one pixel and different for each of the input frames 20 to a perspective projection matrix. The rendering section 302 displaces the viewpoint C for each of the input frames 20 in conformity with a predetermined rule. For example, a Halton sequence is available for this rule.

### Rendering Information Storage Section

The rendering information storage section 304 stores information required by the rendering section 302 for rendering and information obtained by rendering. For example, the rendering information storage section 304 stores the input frames 20. Moreover, the rendering information storage section 304 stores displacement information, motion information, and depth information. Details of the displacement information, the motion information, and the depth information will be discussed below. Further, the rendering information storage section 304 may store fixed parameters described below, parameters used for coordinate conversion, light source information, texture information, normal information, and the like.

### Input Frame Acquisition Section

The input frame acquisition section 306 acquires each of the 1st to Nth (N is a natural number equal to or larger than 2) input frames 20 each containing a predetermined input number of pixels. Specifically, the input frame acquisition section 306 acquires each of the 1st to Nth input frames 20 stored in the rendering information storage section 304. Note that the input frame acquisition section 306 may acquire fixed parameters described below together with the input frames 20.

### First Processed Frame Acquisition Section

The first processed frame acquisition section 308 acquires the first processed frame 22 which contains the input number of pixels each of which has a pixel value having a linear relation with luminance. Specifically, the first processed frame acquisition section 308 performs, for each of the acquired 1st to Nth input frames 20, γ-conversion for establishing a linear relation between pixel values of respective pixels and luminance, to generate the 1st to Nth first processed frames 22. The linear relation between pixel values of the pixels and luminance herein refers to a linear relation between pixel values and luminance when light is emitted from pixels of a display unit in accordance with these pixel values. Meanwhile, a non-linear relation refers to a non-linear relation between pixel values and this luminance.

### Parameter Calculation Section

The parameter calculation section 310 calculates a first parameter indicating brightness of the first processed frame 22 on the basis of luminance distribution of pixels contained in the first processed frame 22. Specifically, for example, the first parameter is an average value of the pixels contained in the first processed frame 22. The parameter calculation section 310 calculates, as the first parameter, an average value of pixel values of all the pixels contained in the first processed frame 22. The parameter calculation section 310 may calculate, as the first parameter, an average value of pixel values in a specific region (e.g., only a region near the center) included in the first processed frame 22. Alternatively, the first parameter may be a median of the pixels contained in the first processed frame 22. In this case, the parameter calculation section 310 may calculate, as the first parameter, a median of pixel values of all the pixels (or pixels in a specific region) contained in the first processed frame 22.

Moreover, the parameter calculation section 310 calculates a second parameter indicating brightness of the learning input frame on the basis of luminance distribution of pixels contained in the learning input frame. Specifically, the second parameter is an average value of pixels contained in the learning input frame to which the linear conversion (the process performed by the first processed frame acquisition section 308) has been applied. For example, the parameter calculation section 310 calculates, as the second parameter, an average value of pixel values of all pixels contained in the learning input frame to which the linear conversion has been applied. The parameter calculation section 310 may calculate, as the second parameter, an average value of pixel values in a specific region (e.g., only a region near the center) included in the learning input frame to which the linear conversion has been applied. Alternatively, the second parameter may be a median of the pixels contained in the learning input frame to which the linear conversion process has been applied. In this case, the parameter calculation section 310 may calculate, as the second parameter, a median of pixel values of all the pixels (or pixels in a specific region) contained in the learning input frame to which the linear conversion has been applied.

Note that the parameter calculation section 310 may calculate the second parameter only at the time of execution of learning. In this case, the second parameter is stored in the machine learning model storage section 318. Moreover, the first parameter and the second parameter are calculated by the same calculation method. Specifically, in a case where the first parameter is calculated on the basis of an average value (or a median), the second parameter is also calculated on the basis of an average value (or a median). In this case, the same pixel region is used for the calculations. Further, the average values and the medians herein are presented only by way of example. The first parameter and the second parameter may be other statistical parameters.

### Displacement Information Acquisition Section

The displacement information acquisition section 312 acquires displacement information. The displacement information acquisition section 312 acquires displacement information stored in the rendering information storage section 304. Specifically, the displacement information is information indicating a displacement amount of the viewpoint C after displacement from the viewpoint C prior to displacement. The information indicating the displacement amount can also be considered as a displacement vector indicating a displacement direction and a displacement distance. For example, a Halton sequence noted above includes information indicating a displacement amount of the viewpoint C. Accordingly, this information is adoptable as the displacement information.

### Second Processed Frame Acquisition Section

The second processed frame acquisition section 314 acquires the second processed frame 24 by performing distribution transformation for the first processed frame 22 on the basis of the first parameter. Specifically, the second processed frame acquisition section 314 performs, for each of the first processed frames 22, distribution transformation for transforming luminance distribution of pixels contained in the corresponding first processed frame 22 into luminance distribution close to that of pixels contained in the learning input frame. For example, the distribution transformation is a process which calculates a correction coefficient on the basis of the first parameter and the second parameter to generate the second processed frame 24 on the basis of the first processed frame 22 and the correction coefficient. The second parameter is a parameter which expresses brightness of the learning input frame. This brightness is calculated on the basis of luminance distribution of pixels contained in the learning input frame to which the linear conversion has been applied as described above. The correction coefficient is calculated by dividing the second parameter by the first parameter. The distribution transformation section generates the second processed frame 24 by multiplying each of pixel values contained in the first processed frame 22 by the correction coefficient. The correction coefficient is also considered as a brightness ratio of the learning input frame to the first processed frame 22.

As described above, the first parameter represents brightness of the first processed frame 22, while the second parameter represents brightness of the learning input frame. The average value of the pixel values of all the pixels contained in the first processed frame 22 can be equalized with the average value of the pixel values of all the pixels contained in the learning input frame by multiplying the each of the pixel values contained in the first processed frame 22 by the correction coefficient calculated by dividing the second parameter by the first parameter. In this manner, luminance distribution of the pixels contained in the first processed frame 22 can be made close to luminance distribution of the pixels contained in the learning input frame.

Note that the second processed frame acquisition section 314 may generate the second processed frame 24 by performing the distribution transformation for the first processed frame 22 on the basis of either the first parameter or the fixed parameter selected in accordance with an instruction from the user. Specifically, in response to reception from the user an instruction for generating the second processed frame 24 on the basis of the first parameter, the second processed frame acquisition section 314 multiplies each of the pixel values contained in the first processed frame 22 by the correction coefficient calculated by dividing the second parameter by the first parameter as described above, to generate the second processed frame 24. On the other hand, in response to reception from the user an instruction for generating the second processed frame 24 on the basis of the fixed parameter, the second processed frame acquisition section 314 multiplies each of the pixel values contained in the first processed frame 22 by the correction coefficient calculated by dividing the second parameter by the fixed parameter, to generate the second processed frame 24. The fixed parameter may be a parameter set by the user beforehand. Expression of brightness desired by the user can be achieved by use of the parameter set by the user. For example, a low value is set for a scene for which overall darkness is desired, and a high value is set for a scene for which overall brightness is desired.

### First Non-Linear Frame Acquisition Section

The first non-linear frame acquisition section 316 generates, on the basis of the second processed frame 24 and a transfer function generated on the basis of a vision of a human, a non-linear frame containing pixel values of pixels each having a non-linear relation with luminance. Specifically, for example, the non-linear conversion section is a perceptual quantizer. The first non-linear frame acquisition section 316 performs γ-conversion for expanding a dynamic range of the second processed frame 24. Moreover, the first non-linear frame acquisition section 316 generates the first non-linear frame 26 having an intermediate number of pixels equal to or larger than the input number of pixels, by performing expansion for the frame generated by the γ-conversion. According to the present embodiment, each of the first non-linear frames 26 has an intermediate number of pixels larger than the input number of pixels. Specifically, according to the present embodiment, each of the first non-linear frames 26 is an image generated by applying distribution transformation and non-linearization to the first processed frame 22 associated with the corresponding first non-linear frame 26 and then expanding the resultant first processed frame 22. In this manner, the first non-linear frame acquisition section 316 acquires each of 1st to Nth first non-linear frames 26 each having the intermediate number of pixels. The machine learning model 200 can achieve high image quality estimation by using the perceptual quantizer.

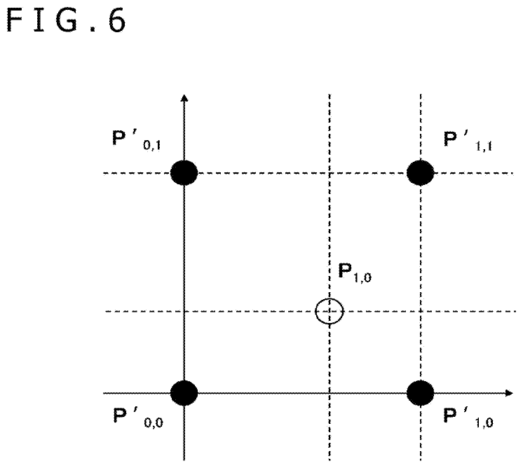

As described above, the first non-linear frames 26 are generated by the processes performed for the input frames 20 acquired by the input frame acquisition section 306. At this time, it is preferable that the first non-linear frame acquisition section 316 generate the first non-linear frames 26 with reference to displacement information. Specifically, for generating each of the first non-linear frames 26, the first non-linear frame acquisition section 316 calculates, by interpolation, pixel values contained in the second processed frame 24 and located at positions corresponding to respective pixels prior to displacement, on the basis of the displacement information and pixels of the second processed frame 24. FIG. 6 is a diagram for explaining processing performed by the second processed frame acquisition section 314. FIG. 6 illustrates an example of acquisition of the nth first non-linear frame 26_n. For example, assuming that a pixel center of a certain pixel contained in the first non-linear frame 26_n to be acquired is (P1,0) as illustrated in FIG. 6, the first non-linear frame acquisition section 316 calculates a pixel value of (P1, 0) by bilinear interpolation on the basis of coordinates and pixel values of pixel centers (P′0,0), (P′1,0), (P′0,1), and (P′1,1) of four pixels closest to (P1,0) in the second processed frame 24_n. Note herein that (P′1,0) is located at a position shifted from (P1, 0) by a displacement amount indicated by displacement information. Pixel values of pixels newly generated by the expansion are also calculated in a similar manner. Note that various known methods such as bicubic interpolation and Lanczos interpolation are adoptable as an interpolation method, in addition to the bilinear interpolation.

The amount of time-series information increases by rendering executed such that the viewpoint C is displaced for each of the input frames 20. The second non-linear frame 28 having higher image quality is acquirable if the first non-linear frames 26 obtained in this manner (hereinafter referred to as “displaced input frames”) are used for estimation.

However, when the displaced input frames (or images generated by expanding these frames) are input to the machine learning model 200 without change, accuracy of estimation may be lowered by the influence of displacement of the viewpoint C noted above.

In view of this, as described above, the image processing system 1 calculates, by interpolation, pixel values contained in each of the second processed frames 24 and located at positions corresponding to respective pixels prior to displacement, on the basis of the displacement information and the pixels of the corresponding second processed frame 24, generates the first non-linear frames 26, and inputs the generated first non-linear frames 26 to the machine learning model 200. In this manner, the influence of displacement of the viewpoint C is corrected. Accordingly, lowering of the estimation accuracy can be reduced.

### Machine Learning Model

The machine learning model 200 is a model which estimates the nth second non-linear frame 28_n on the basis of the nth first non-linear frame 26_n. Specifically, the machine learning model 200 is a model which estimates the nth second non-linear frame 28_n on the basis of the nth first non-linear frame 26_n and the (n−1)th supplementary information 38_n−1. Specifically, the machine learning model 200 is a convolutional neural network (CNN). For example, known models such as multilayer-structured ResNet having a residual connection and what is generally called encoder-decoder type U-Net are adoptable as the machine learning model 200. The model presented in Non Patent Document 1 may be employed as the machine learning model 200.

The machine learning model 200 is a model trained on the basis of training data which includes a learning input moving image containing a learning input frame which has a predetermined input number of pixels and a learning output moving image containing a learning output frame which has an estimated number of pixels larger than the input number of pixels. Various known methods such as a backpropagation method are available for learning of the machine learning model 200.

Specifically, the machine learning model 200 includes the cumulative feature information output layer 202, the second non-linear frame output layer 204, and a convolution layer 206 (see FIGS. 2A and 2B).

The cumulative feature information output layer 202 receives input of the nth first non-linear frame 26_n, and the (n−1)th supplementary information 38_n−1 based on the (n−1)th cumulative feature information 36_n−1 indicating features of the 1st to (n−1)th first non-linear frames 26, and outputs the nth cumulative feature information 36_n indicating features the 1st to nth first non-linear frames 26_n. For example, the cumulative feature information output layer 202 may include one or more convolution layers. The cumulative feature information 36_n−1 is image information (bitmap format information) which has the same number of pixels as the intermediate number of pixels. The cumulative feature information 36_n−1 can also be considered as a feature map indicating features of the 1st to (n−1)th first non-linear frames 26.

Note that the cumulative feature information output layer 202 receives input of the 1st first non-linear frame 26_1 and given supplementary information 38, and outputs the first cumulative feature information 36_1. In the case of n=1, the cumulative feature information 36 and the supplementary information 38 before n=1 are absent. Accordingly, the given supplementary information 38 prepared beforehand is input to the cumulative feature information output layer 202 together with the first non-linear frame 26_1.

The second non-linear frame output layer 204 receives input of the nth cumulative feature information 36_n, and outputs the nth second non-linear frame 28_n. For example, the second non-linear frame output layer 204 may include one or more convolution layers similarly to the cumulative feature information output layer 202. Alternatively, the second non-linear frame output layer 204 may include one or more transposed convolution layers (deconvolution layers).

The convolution layer 206 is a layer which reduces the number of channels of the cumulative feature information 36 while maintaining the number of pixels thereof. The cumulative feature information 36 output from the convolution layer 206 is subjected to processing performed by the supplementary information acquisition section 328. The convolution layer 206 reduces the dimension of the cumulative feature information 36. Accordingly, reduction of calculation costs is achievable. For example, the convolution layer 206 is constituted by, but not limited to, a convolution layer having a kernel size of 1×1.

### Machine Learning Model Storage Section

The machine learning model storage section 318 stores the machine learning model 200. Specifically, the machine learning model storage section 318 stores parameters (e.g., the number of convolution layers, the number of nodes used by each of the convolution layers, and weights of the nodes) of the machine learning model 200.

### Second Non-Linear Frame Acquisition Section

The second non-linear frame acquisition section 320 inputs the first non-linear frame 26 to the machine learning model 200 to generate the second non-linear frame 28 having the number of pixels equal to or larger than the intermediate number of pixels. Specifically, the second non-linear frame acquisition section 320 inputs the first non-linear frames 26 to the machine learning model 200 to acquire each of 1st to Nth second non-linear frames 28 each having an estimated number of pixels larger than the input number of pixels and equal to or larger than the intermediate number of pixels. According to the present embodiment, each of the second non-linear frames 28 has an estimated number of pixels equal to the intermediate number of pixels. More specifically, the second non-linear frame acquisition section 320 inputs the nth first non-linear frame 26_n and the (n−1)th supplementary information 38_n−1 to the machine learning model 200 to acquire the nth second non-linear frame 28_n.

### Motion Information Acquisition Section

The motion information acquisition section 322 acquires (n−1)th motion information, which is information indicating motion amounts and motion directions from the (n−1)th input frame 20_n−1 to the nth input frame 20_n. Specifically, the (n−1)th motion information is image information which has the same number of pixels as the intermediate number of pixels and indicates motion amounts and motion directions of respective pixels between the (n−1)th input frame 20_n−1 and the nth input frame 20_n (bitmap format information). The motion information is also called a motion vector. Specifically, the motion information acquisition section 322 acquires original motion information which has the same number of pixels as the input number of pixels, and executes expansion and interpolation for this original motion information to acquire motion information having the same number of pixels as the intermediate number of pixels. Note that the (n−1)th motion information is also information indicating motion amounts and motion directions from the (n−1)th second processed frame 24_n−1 to the nth second processed frame 24_n.

### Depth Information Acquisition Section

The depth information acquisition section 324 acquires (n−1)th depth information indicating depths of respective pixels of the (n−1)th input frame 20_n−1 and nth depth information indicating depths of respective pixels of the nth input frame 20_n. Specifically, the depth information is image information having the same number of pixels as the intermediate number of pixels (bitmap format information). The depth information is also called a depth buffer or a Z buffer. Specifically, the depth information acquisition section 324 acquires original depth information which has the same number of pixels as the input number of pixels, and executes expansion and interpolation for this original depth information to acquire depth information having the same number of pixels as the intermediate number of pixels. Note that the nth depth information is also information indicating depths of respective pixels of the nth second processed frame 24_n.

### Appearing Pixel Identification Section

The appearing pixel identification section 326 identifies, on the basis of the (n−1)th depth information and the nth depth information, an nth appearing pixel 222_n which is a pixel not displayed in the (n−1)th input frame 20_n−1 but displayed in the nth input frame 20_n as the whole or a part of the game object O (see FIG. 3). Specifically, the appearing pixel identification section 326 identifies the nth appearing pixel 222_n on the basis of a difference between the (n−1)th depth information and the nth depth information. Note that the appearing pixel identification section 326 may identify the nth appearing pixel 222_n on the basis of an (n−1)th perspective projection matrix associated with the (n−1)th input frame 20_n−1 and an nth perspective projection matrix associated with the nth input frame 20_n. Moreover, the appearing pixel identification section 326 may identify the nth appearing pixel 222_n by using the (n−1)th motion information. In addition, more specifically, the appearing pixel identification section 326 identifies the nth appearing pixel 222_n, and generates nth appearing pixel information which is image information indicating the position of the nth appearing pixel 222_n. Further, the nth appearing pixel 222_n is also a pixel not displayed in the (n−1)th second processed frame 24_n−1 but displayed in the nth second processed frame 24_n as the whole or a part of the game object O.

Supplementary information acquisition section

The supplementary information acquisition section 328 acquires the (n−1)th supplementary information 38_n−1 by applying motion compensation to the (n−1)th cumulative feature information 36_n−1 on the basis of the (n−1)th motion information. For example, the motion compensation refers to a process for shifting a pixel located at a position x in the (n−1)th cumulative feature information 36_n to a position x′ in a case where a pixel located at the position x in the (n−1)th second processed frame 24_n−1 moves to the position x′ in the nth second processed frame 24_n (see FIG. 3). Specifically, the supplementary information acquisition section 328 sets, on the basis of the (n−1)th motion information, each pixel value of one or more pixels of the (n−1)th cumulative feature information 36_n−1 to the corresponding pixel located at a position shifted in accordance with a motion amount and a motion direction of the pixel, to acquire the (n−1)th supplementary information 38_n−1.

If the nth first non-linear frame 26_n and the (n−1)th cumulative feature information 36_n−1 are input to the machine learning model 200 without change to acquire the nth second non-linear frame 28_n in the presence of motion of the game object O between the nth input frame 20_n and the (n−1)th input frame 20_n−1, a ghost phenomenon in which an afterimage of the game object O displayed in the nth first non-linear frame 26_n is displayed may occur in the nth second non-linear frame 28_n that is output.

Accordingly, the image processing system 1 applies motion compensation to the (n−1)th cumulative feature information 36_n−1 on the basis of the (n−1)th motion information as described above to acquire the (n−1)th supplementary information 38_n−1, and inputs the (n−1)th supplementary information 38_n−1 thus acquired to the machine learning model 200 at the time of acquisition of the nth second non-linear frame 28_n. In this manner, the ghost phenomenon noted above can be reduced.

Moreover, the supplementary information acquisition section 328 acquires the (n−1)th supplementary information 38_n−1 by replacing the pixel value of the nth appearing pixel 222_n contained in the (n−1)th cumulative feature information 36_n−1 with a predetermined value. Specifically, the supplementary information acquisition section 328 acquires the (n−1)th supplementary information 38_n−1 by replacing the pixel value of the nth appearing pixel 222_n contained in the (n−1)th cumulative feature information 36_n−1 with a predetermined value on the basis of the nth appearing pixel information. For example, the predetermined value may be a fixed value such as 0 (black), or a pixel value of the nth appearing pixel 222_n in the nth second processed frame 24_n.

If the nth first non-linear frame 26_n and the (n−1)th cumulative feature information 36_n−1 are input to the machine learning model 200 without change to acquire the nth second non-linear frame 28_n in a state where the whole or a part of the game object O is not displayed in the (n−1)th input frame 20_n−1 but displayed in the nth input frame 20_n, the foregoing ghost phenomenon can occur in the nth second non-linear frame 28_n that is output.

Accordingly, the image processing system 1 identifies the nth appearing pixel 222_n corresponding to a pixel not displayed in the (n−1)th first non-linear frame 26_n−1 but displayed as the whole or a part of the game object O in the nth first non-linear frame 26_n as described above, and replaces the pixel value of the nth appearing pixel 222_n in the (n−1)th cumulative feature information 36_n−1 with a predetermined value to acquire the (n−1)th supplementary information 38_n−1. In this manner, the ghost phenomenon noted above can be reduced.

### Third Processed Frame Acquisition Section

The third processed frame acquisition section 330 generates, on the basis of the second non-linear frame 28, the third processed frame 30 which contains pixel values of pixels each having a linear relation with luminance. Specifically, the third processed frame acquisition section 330 generates the third processed frame 30 by inputting the second non-linear frame 28 to the inverse function of the transfer function used for generating the first non-linear frame 26 from the second processed frame 24. As noted above, in cases where the transfer function corresponding to a perceptual quantizer is used to generated the first non-linear frame 26 from the second non-linear frame 28, the third processed frame acquisition section 330 inputs the second non-linear frame 28 to the inverse function of the transfer function corresponding to the perceptual quantizer to generate the third processed frame 30.

### Fourth Processed Frame Acquisition Section

The fourth processed frame acquisition section 332 generates the fourth processed frame 32 by performing inverse distribution transformation for the third processed frame 30 on the basis of the first parameter. Specifically, the inverse distribution transformation is an inverse process of distribution transformation and transforms luminance distribution of pixels contained in the third processed frame 30 into luminance distribution close to that of pixels contained in the first processed frame 22. In the case of the above example, the fourth processed frame acquisition section 332 calculates an inverse correction coefficient by dividing the first parameter by the second parameter, and multiplies each of pixel values contained in the third processed frame 30 by this inverse correction coefficient, to generate the fourth processed frame 32.

As described above, the first parameter represents brightness of the first processed frame 22, while the second parameter represents brightness of the learning input frame. An average value of pixel values of all pixels contained in the third processed frame 30 can be equalized with an average value of pixel values of all pixels contained in the input frame 20 by multiplying each of the pixel values contained in the third processed frame 30 by the inverse correction coefficient calculated by dividing the first parameter by the second parameter. In this manner, the luminance distribution of the pixels contained in the input frame 20 can be restored from the luminance distribution of the pixels contained in the third processed frame 30.

### Output Frame Acquisition Section

The output frame acquisition section 334 performs non-linear conversion for the fourth processed frame 32 to generate the output frame 34. This non-linear conversion is an inverse process of the γ-conversion performed for generating the first processed frame 22 from the input frame 20. In this manner, the output frame 34 in which a relation between pixel values and luminance is similar to that of the input frame 20 is generated.

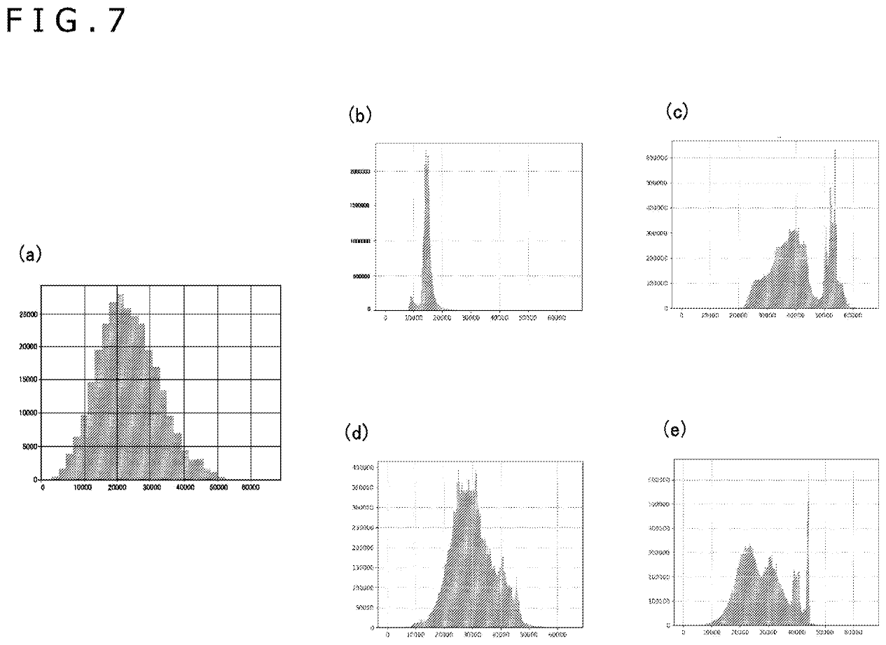

According to the present embodiment described above, distribution transformation is performed, before output of an estimated image, to transform luminance distribution into luminance distribution close to that in the learning input frame. In this manner, a high-quality estimated image can be output even in cases of input of the input frame 20 having luminance distribution considerably different from that in the learning input frame and the learning output frame. (a) of FIG. 7 illustrates an example of a histogram representing a relation between pixel values in the learning input frame and frequencies. (b) of FIG. 7 to (e) of FIG. 7 each illustrate an example of a histogram representing a relation between pixel values in the corresponding input frame 20 and frequencies. Luminance distribution is biased in each of (b) of FIG. 7 and (c) of FIG. 7, and is considerably different from luminance distribution in the learning input frame. Meanwhile, luminance distribution is less biased in each of (d) of FIG. 7 and (e) of FIG. 7, and is less different from luminance distribution in the learning input frame. A conventional machine learning model can output a high-quality estimated image on the basis of the input frame 20 having luminance distribution illustrated in (d) of FIG. 7 and (e) of FIG. 7, but cannot output a high-quality estimated image on the basis of the input frame 20 having luminance distribution illustrated in (b) of FIG. 7 and (c) of FIG. 7. According to the present embodiment, a high-quality estimated image can be output by performing distribution transformation even on the basis of the input frame 20 having luminance distribution illustrated in (d) of FIG. 7 and (e) of FIG. 7.

### 4. Processes Executed by Image Processing System

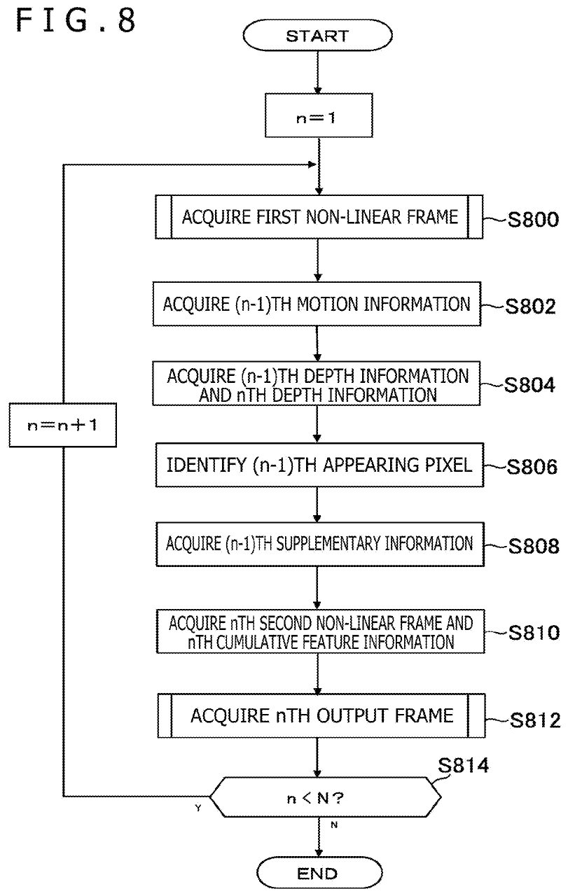

FIGS. 8, 9, and 10 are flowcharts illustrating an example of a flow of processes executed by the image processing system 1. The processes illustrated in FIGS. 8, 9, and 10 are executed by the control device 10 operating in accordance with a program stored in the storage device 12.

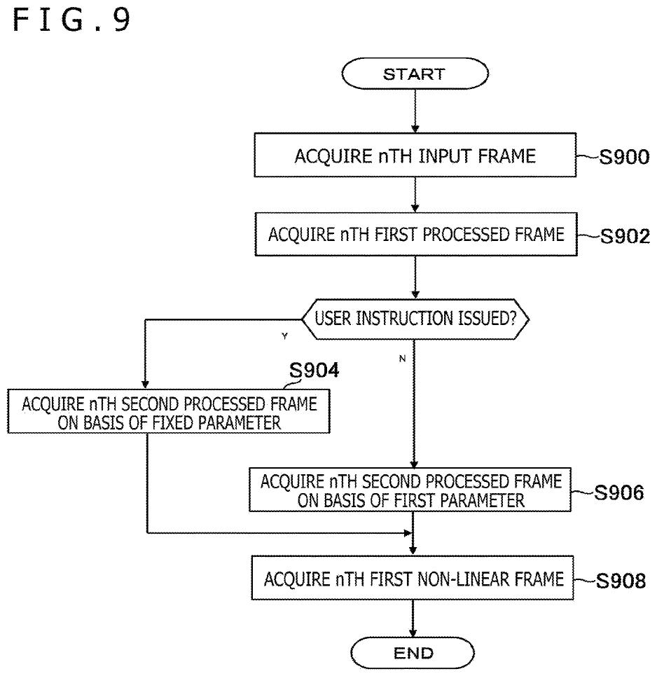

First, the control device 10 acquires the nth first non-linear frame 26_n (S800). FIG. 9 is a flowchart illustrating a flow for acquiring the nth first non-linear frame 26_n. The control device 10 acquires the nth input frame 20_n (S900). The control section performs, for the nth input frame 20_n, γ-conversion for establishing a linear relation between pixel values of respective pixels and luminance, to acquire the nth first processed frame 22_n (S902). Subsequently, in a case of presence of an instruction from the user, the control device 10 multiplies each of pixel values contained in the first processed frame 22 by a correction coefficient calculated by dividing a second parameter by a fixed parameter designated by the user, to generate the second processed frame 24 (S904). On the other hand, in a case of absence of an instruction from the user, the control device 10 calculates an average value of pixels contained in the first processed frame 22 as a first parameter, calculates a correction coefficient by dividing the second parameter by the first parameter, and multiplies each of the pixel values contained in the first processed frame 22 by the correction coefficient, to generate the second processed frame 24 (S906). Thereafter, the control device 10 inputs the second processed frame 24 to the perceptual quantizer, and further performs expansion to acquire the nth first non-linear frame 26_n having the intermediate number of pixels (S908).

As described above, the user is allowed to select the fixed parameter at the time of generation of the second processed frame 24. Accordingly, expression of brightness desired by the user is achievable. Meanwhile, in a case where the user does not know an appropriate value of the correction coefficient, optimal brightness can appropriately be expressed by use of the first parameter. Accordingly, the correction coefficient is what is generally a called exposure value, and corresponds to a parameter for determining brightness of frames to be generated. The method for determining the correction coefficient is not limited to the above method. The value obtained by the above calculation method may be further multiplied by a given constant. Moreover, the fixed parameter may be a value different for each frame.

Subsequently, the control device 10 generates the second non-linear frame 28 from the first non-linear frame 26 (S802 to S810). The control device 10 acquires the (n−1)th motion information (S802). Moreover, the control device 10 acquires the (n−1)th depth information and the nth depth information (S804), and identifies the nth appearing pixel 222_n on the basis of the (n−1)th depth information and the nth depth information (S806). The control device 10 acquires the (n−1)th supplementary information 38_n−1 on the basis of the (n−1)th cumulative feature information 36_n−1, the (n−1)th motion information, and the nth appearing pixel 222_n (S808). Thereafter, the control device 10 inputs the nth first non-linear frame 26_n and the (n−1)th supplementary information 38_n−1 to the machine learning model 200 to acquire the nth second non-linear frame 28_n and the nth cumulative feature information 36_n (S810). Note that the first supplementary information 38_1 is absent for n=1. Accordingly, the first supplementary information 38_1 may be the first supplementary information 38_1 set beforehand.

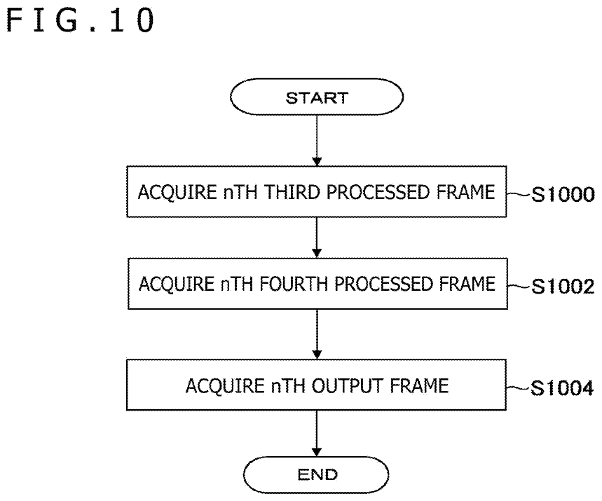

Subsequently, the control device 10 generates the output frame 34 from the second non-linear frame 28 (S812). FIG. 10 is a flowchart illustrating a flow for generating the nth output frame 34_n on the basis of the nth second non-linear frame 28_n. The control device 10 inputs the nth second non-linear frame 28_n to the inverse function of the transfer function corresponding to the perceptual quantizer to generate the nth third processed frame 30_n (S1000). The control device 10 calculates an inverse correction coefficient by dividing the first parameter by the second parameter, and multiplies each of pixel values contained in the nth third processed frame 30_n by this inverse correction coefficient to generate the nth fourth processed frame 32_n (S1002). Moreover, the control device 10 performs the inverse process of the γ-conversion carried out at the time of generation of the nth first processed from 22_n from the nth input frame 20_n, to generate the nth output frame 34_n (S1004).

The control device 10 determines whether or not a subsequent frame is present (S814). In a case where a subsequent frame is determined to be present (S814: Y), n is incremented to n+1 to repeat the processing from S800 to S812. In a case where a subsequent frame is determined to be absent (S814: N), the control device 10 ends the present process. Note that the control device 10 may cause the display device 18 to display the 1st to Nth output frames 34 without change in the case where a subsequent frame is determined to be absent (S814: N).

### 5. Summary

According to the image processing system 1 of the present embodiment described above, distribution transformation is performed, before output of an estimated image, to transform luminance distribution into luminance distribution close to that in the learning input frame. In this manner, a high-quality estimated image can be output even in cases of input of the input frame 20 having luminance distribution considerably different from that in the learning input frame and the learning output frame. Moreover, brightness of the output frame 34 to be generated can appropriately be changed in accordance with an instruction from the user.

Further, the nth second non-linear frame 28_n is estimated on the basis of the (n−1)th cumulative feature information 36_n−1 indicating features of the 1st to (n−1)th first non-linear frames 26. Specifically, information associated with the 1st to (n−1)th first non-linear frames 26 is available for estimation in addition to information associated with the nth first non-linear frame 26_n. Accordingly, the information amount available for estimation increases, and therefore, the second non-linear frame 28_n to be acquired has higher image quality.

Note that the invention associated with the present disclosure is not limited to the embodiment described above. Moreover, the specific character strings and the numerical values described above and the specific character strings and the numerical values included in the figures are presented only by way of example. Character strings and numerical values to be employed are not limited to these.

For example, while discussed in the present embodiment has been the example where the intermediate number of pixels is larger than the input number of pixels and equivalent to the estimated number of pixels, the intermediate number of pixels may be equivalent to the input number of pixels and the estimated number of pixels is larger than the intermediate number of pixels. In other words, the second processed frame 24 is not necessarily limited to an enlarged frame of the input frame 20.

### 6. Supplementary note

(1)

An image processing system including:
a processor;
a storage unit that stores a command executed by the processor, and a resolution conversion section including a machine learning model; and
a display unit, in which
the machine learning model is a model trained on the basis of training data that includes a learning input moving image containing a learning input frame having a predetermined input number of pixels and a learning output moving image containing a learning output frame having an estimated number of pixels larger than the input number of pixels, and
the processor
   acquires a first processed frame that has the input number of pixels each of which has a pixel value having a linear relation with luminance,
   calculates a first parameter indicating brightness of the first processed frame on the basis of luminance distribution of the pixels contained in the first processed frame,
   performs, for the first processed frame, distribution transformation that transforms the luminance distribution of the pixels contained in the first processed frame into luminance distribution close to that of the pixels contained in the learning input frame on the basis of the first parameter to generate a second processed frame,
   inputs the second processed frame to the resolution conversion section to generate a third processed frame having the estimated number of pixels each of which has a pixel value having a linear relation with luminance, and
performs, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.
(2)

The distribution transformation is a process that generates the second processed frame by
calculating a second parameter indicating brightness of the learning input frame on the basis of the luminance distribution of the pixels contained in the learning input frame,
calculating a correction coefficient by dividing the second parameter by the first parameter, and
multiplying each of the pixel values contained in the first processed frame by the correction coefficient.
(3)

The processor inputs the second processed frame to a transfer function constituting a perceptual quantizer, and carries out expansion of the second processed frame to generate a first non-linear frame that has an intermediate number of pixels equal to or larger than the input number of pixels.
(4)

The processor inputs the first non-linear frame to the machine learning model to generate a second non-linear frame that contains the estimated number of pixels.
(5)

The processor inputs the second non-linear frame to an inverse function of the transfer function constituting the perceptual quantizer to generate the third processed frame.
(6)

The inverse distribution transformation is a process that generates the fourth processed frame by
calculating an inverse correction coefficient by dividing the first parameter by the second parameter, and
multiplying each of the pixel values contained in the third processed frame by the inverse correction coefficient.
(7)

The first parameter is an average value of the pixel values of the pixels contained in the first processed frame, and
the second parameter is an average value of the pixel values of the pixels contained in the learning input frame.
(8)

The first parameter is a median of the pixel values of the pixels contained in the first processed frame, and
the second parameter is a median of the pixel values of the pixels contained in the learning input frame.
(9)

The processor performs, for the first processed frame, the distribution transformation on the basis of either the first parameter or a given fixed parameter selected in accordance with an instruction from a user, to generate the second processed frame.
(10)

An image processing method including:
by a processor,
acquiring a first processed frame that has an input number of pixels each of which has a pixel value having a linear relation with luminance;
calculating a first parameter indicating brightness of the first processed frame on the basis of luminance distribution of the pixels contained in the first processed frame;
performing, for the first processed frame, distribution transformation that transforms the luminance distribution of the pixels contained in the first processed frame into luminance distribution close to that of pixels contained in the learning input frame on the basis of the first parameter to generate a second processed frame;
inputting the second processed frame to a resolution conversion section to generate a third processed frame that has an estimated number of pixels each of which has a pixel value having a linear relation with luminance,
   the resolution conversion section including a machine learning model, and
   the machine learning model being a model trained on the basis of training data that includes a learning input moving image containing the learning input frame having a predetermined input number of pixels and a learning output moving image containing a learning output frame having the estimated number of pixels larger than the input number of pixels; and
   performing, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.
(11)

A non-transitory computer-readable information storage medium for storing a program that causes a computer to function as:
first processed frame acquisition means that acquires a first processed frame that has an input number of pixels each of which has a pixel value having a linear relation with luminance;
first parameter calculation means that calculates a first parameter indicating brightness of the first processed frame on the basis of luminance distribution of the pixels contained in the first processed frame;
second processed frame generation means that performs, for the first processed frame, distribution transformation that transforms the luminance distribution of the pixels contained in the first processed frame into luminance distribution close to that of pixels contained in the learning input frame on the basis of the first parameter to generate a second processed frame;
third processed frame generation means that inputs the second processed frame to a resolution conversion section to generate a third processed frame that has an estimated number of pixels each of which has a pixel value having a linear relation with luminance,
   the resolution conversion section including a machine learning model, and
   the machine learning model being a model trained on the basis of training data that includes a learning input moving image containing the learning input frame having a predetermined input number of pixels and a learning output moving image containing a learning output frame having the estimated number of pixels larger than the input number of pixels; and
fourth processed frame generating means that performs, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.

What is claimed is:

1. An image processing system comprising:
a processor; and
computer-readable media storing instructions which, when executed by the processor, cause the image processing system to perform operations comprising:
acquiring a first processed frame that has an input number of pixels each of which has a pixel value having a linear relation with luminance,
calculating a first parameter indicating brightness of the first processed frame on a basis of luminance distribution of the pixels contained in the first processed frame,
performing, for the first processed frame, distribution transformation that transforms the luminance distribution of the pixels contained in the first processed frame into luminance distribution close to that of the pixels contained in a learning input frame on a basis of the first parameter to generate a second processed frame,
inputting the second processed frame to a resolution conversion section to generate a third processed frame having an estimated number of pixels each of which has a pixel value having a linear relation with luminance, and
performing, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.

2. The image processing system according to claim 1, wherein
the distribution transformation is a process that generates the second processed frame by
calculating a second parameter indicating brightness of the learning input frame on a basis of the luminance distribution of the pixels contained in the learning input frame,
calculating a correction coefficient by dividing the second parameter by the first parameter, and
multiplying each of the pixel values contained in the first processed frame by the correction coefficient.

3. The image processing system according to claim 2, wherein the operations further comprise:
inputting the second processed frame to a transfer function constituting a perceptual quantizer, and performing expansion of the second processed frame to generate a first non-linear frame that has an intermediate number of pixels equal to or larger than the input number of pixels.

4. The image processing system according to claim 3, wherein the operations further comprise:
inputting the first non-linear frame to a machine learning model to generate a second non-linear frame that contains the estimated number of pixels.

5. The image processing system according to claim 4, wherein the operations further comprise:
inputting the second non-linear frame to an inverse function of the transfer function constituting the perceptual quantizer to generate the third processed frame.

6. The image processing system according to claim 5, wherein
the inverse distribution transformation is a process that generates the fourth processed frame by
calculating an inverse correction coefficient by dividing the first parameter by the second parameter, and
multiplying each of the pixel values contained in the third processed frame by the inverse correction coefficient.

7. The image processing system according to claim 6, wherein
the first parameter is an average value of the pixel values of the pixels contained in the first processed frame, and
the second parameter is an average value of the pixel values of the pixels contained in the learning input frame.

8. The image processing system according to claim 6, wherein
the first parameter is a median of the pixel values of the pixels contained in the first processed frame, and
the second parameter is a median of the pixel values of the pixels contained in the learning input frame.

9. The image processing system according to claim 8, wherein the operations further comprise:
performing, for the first processed frame, the distribution transformation on a basis of either the first parameter or a given fixed parameter selected in accordance with an instruction from a user, to generate the second processed frame.

10. A computer-implemented method comprising:
acquiring a first processed frame that has an input number of pixels each of which has a pixel value having a linear relation with luminance;
calculating a first parameter indicating brightness of the first processed frame on a basis of luminance distribution of the pixels contained in the first processed frame;
performing, for the first processed frame, distribution transformation that transforms the luminance distribution of the pixels contained in the first processed frame into luminance distribution close to that of pixels contained in the learning input frame on a basis of the first parameter to generate a second processed frame;
inputting the second processed frame to a resolution conversion section to generate a third processed frame that has an estimated number of pixels each of which has a pixel value having a linear relation with luminance, the resolution conversion section including:
a machine learning model, wherein the machine learning model comprises a model trained on a basis of training data that includes a learning input moving image containing the learning input frame having a predetermined input number of pixels and a learning output moving image containing a learning output frame having the estimated number of pixels larger than the input number of pixels; and
performing, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.

11. A non-transitory computer-readable information storage medium for storing a program which, when executed by one or more processors, causes a system to perform operations comprising:
acquiring a first processed frame that has an input number of pixels each of which has a pixel value having a linear relation with luminance;
calculating a first parameter indicating brightness of the first processed frame on a basis of luminance distribution of the pixels contained in the first processed frame;
performing, for the first processed frame, distribution transformation that transforms the luminance distribution of the pixels contained in the first processed frame into luminance distribution close to that of pixels contained in the learning input frame on a basis of the first parameter to generate a second processed frame;
inputting the second processed frame to a resolution conversion section to generate a third processed frame that has an estimated number of pixels each of which has a pixel value having a linear relation with luminance, the resolution conversion section including:
a machine learning model, wherein the machine learning model comprises a model trained on a basis of training data that includes a learning input moving image containing the learning input frame having a predetermined input number of pixels and a learning output moving image containing a learning output frame having the estimated number of pixels larger than the input number of pixels; and
performing, for the third processed frame, inverse distribution transformation that is an inverse process of the distribution transformation and transforms luminance distribution of the pixels contained in the third processed frame into luminance distribution close to that of the pixels contained in the first processed frame on the basis of the first parameter to generate a fourth processed frame.
